(19) United States
(12) Patent Application Publication
(10) Pub. No.: US 2005/0003318 A1
(43) Pub. Date: Jan. 6, 2005

(54) Orthodontic appliance by using a shape memory polymer

(76) Inventors: Young-Kyu Choi, Seoul (KR); Ki-Tae Kim, Seoul (KR)

Correspondence Address: MINTZ LEVIN COHN FERRIS GLOVSKY & POPEO, 666 THIRD AVENUE, NEW YORK, NY, 10017, US

(21) Appl. No.: 10/482,449

(22) PCT Filed: Jun. 28, 2002
(86) PCT No.: PCT/KR02/01237

(30) Foreign Application Priority Data
Jul. 2, 2001 (KR) 2001/39240

(51) Int. Cl. A61C 3/00

(52) U.S. Cl. 433/6; 433/24

(57) ABSTRACT

Disclosed is an orthodontic appliance for straightening misaligned teeth. The orthodontic appliance is made of a shape memory polymer, and is formed in a cap-shaped tray capable of covering the maxillary or mandibular teeth. An original shape of the tray-type orthodontic appliance made of the shape memory polymer is identical to that of perfectly aligned teeth obtained after orthodontic treatment, and a temporarily formed shape of the tray-type orthodontic appliance is identical to that of the teeth alignment of a patient before orthodontic treatment. The tray-type orthodontic appliance is restored to the original shape memorized at a temperature above a specified glass transition temperature. The orthodontic appliance can be easily manufactured to perform orthodontic treatment, also providing appealing esthetics, in which the orthodontic appliance can be colored to be identical to a tooth with inexpensive manufacturing cost.

### TECHNICAL FIELD

The present invention relates to an orthodontic appliance, and in particular, to an orthodontic appliance made of a shape memory polymer capable of being restored to its original shape at a temperature lower than a predetermined temperature.

### BACKGROUND ART

In general, malocclusion refers to the state in which teeth are crooked or poorly aligned. Orthodontics refers to the treatment for straightening teeth. In case of the malocclusion of teeth or teeth misalignment, the following problems exist: unappealing appearance; difficulty in or when chewing food; and poor pronunciation of words. In order to eliminate these problems, various orthodontic appliances have been developed.

Several types of orthodontic appliances, which include removable, fixed, and extra-oral orthodontic appliances are generally used and well known in the art.

First of all, a removable orthodontic appliance is one that a wearer can apply or put into his or her mouth by himself or herself, and generally has a large size. The wearer also has to pay close attention to its maintenance.

A fixed orthodontic appliance is one that it is attached and fixed to the teeth. The size of the fixed orthodontic appliance is smaller than that of the removable orthodontic appliance and can correctly implement orthodontic treatment. Generally, the fixed orthodontic appliance includes a bracket serving as a metal support, and a wire. The bracket is attached to the surface of the teeth and the wire is inserted into the slots of the bracket so that pushing or pulling the wire makes a position of teeth slowly altered, thereby correcting the misaligned teeth. Although the most typical fixed orthodontic appliance employs a metal bracket, there are other types employing a gold bracket or a ceramic bracket.

An extra-oral orthodontic appliance is used in conjunction with a removable or fixed orthodontic appliance, in order to obtain a supporting or movement force from external anatomical structures upon the movement of the teeth.

Meanwhile, since the above-mentioned orthodontic appliances are mainly made of metal, a drawback exists in that the wearer must wear unsightly brackets and wires for a significant period of time.

In order to remedy this drawback, a lingual orthodontic technique has been developed where a bracket is attached to the internal side of the teeth facing the tongue, which prevents the orthodontic appliance from being seen from the exterior. (See Japanese Utility-Model Publication No. Sho 57-44967, U.S. Pat. No. 4,337,037, and Korean Patent Application No. 1999-7009678.)

However, this lingual orthodontic technique has the following problems: the bracket must be separately manufactured to conform to the groove formed on the inside of the teeth; precision in treatment is required, since the wire is threaded in a narrow oral cavity; and since the bracket and wire are attached within the oral cavity, it is difficult to chew food and the wearer has a speech impediment for an extended period of time after performing the treatment.

Furthermore, since a fixed orthodontic appliance requires the periodic adjustment (i.e., pushing or pulling) on the wire mounted to the bracket, continuous maintenance is required. In every instance where the orthodontic appliance is maintained, the wearer will suffer pain.

### DISCLOSURE OF THE INVENTION

Therefore, an object of the present invention is to solve the problems involved in the prior art, and to provide an orthodontic appliance using a shape memory polymer.

Another object of the present invention is to provide an orthodontic appliance capable of being easily mounted to the patient's (or wearer's) teeth, so that the patient (or wearer) does not suffer from pain to his or her mouth.

Still another object of the present invention is to provide an orthodontic appliance having no additional adjusting process, such as pushing or pulling, after it is mounted to the patient's (or wearer's) teeth.

Still another object of the present invention is to provide an inexpensive orthodontic appliance made of material having the same color as that of teeth or a transparent color, thereby making it less noticeable.

In order to accomplish the above-mentioned objects, the present invention provides an orthodontic appliance for straightening misaligned teeth made of a shape memory polymer and formed in a cap-shaped tray capable of covering maxillary or mandibular teeth, wherein the original shape of the tray-type orthodontic appliance made of the shape memory polymer is identical to that of perfectly aligned teeth obtained after orthodontic treatment, and a temporarily formed shape of the tray-type orthodontic appliance is identical to that of the alignment of a patient's teeth before orthodontic treatment, and wherein the tray-type orthodontic appliance is restored to the original shape at a temperature above a specified glass transition temperature.

The orthodontic appliance is adapted to cover teeth or both of teeth and palate when the appliance is used for a maxilla.

In another aspect of the present invention, a molar upstanding orthodontic appliance made of a shape memory polymer and formed in a cap-shaped tray capable of covering only predetermined teeth is provided, wherein the original shape of the tray-type orthodontic appliance made of the shape memory polymer is identical to that of perfectly aligned teeth obtained after orthodontic treatment, and a temporarily formed shape of the tray-type orthodontic appliance is identical to that of the alignment of the patient's teeth before orthodontic treatment, and wherein the tray-type orthodontic appliance is restored to its original shape at a temperature above a specified glass transition temperature.

In still another aspect of the present invention, there is provided an orthodontic appliance for straightening misaligned teeth formed in a band having a predetermined width and length, wherein the band-type orthodontic appliance made of a shape memory polymer is restored to its original shape at a temperature above a specified glass transition temperature.

In still another aspect of the present invention, there is provided an orthodontic appliance for straightening misaligned teeth made of a shape memory polymer having a predetermined glass transition temperature and formed in a mouthguard capable of completely covering maxillary or mandibular teeth, wherein the original shape of the mouthguard-type orthodontic appliance made of a shape memory polymer is identical to that of perfectly aligned teeth obtained after orthodontic treatment, and a temporarily formed shape of the mouthguard-type orthodontic appliance is identical to that of the alignment of the patient's teeth before orthodontic treatment, wherein the mouthguard-type orthodontic appliance is restored to its original shape at a temperature above a specified glass transition temperature.

In still another aspect of the present invention, there is provided a method for manufacturing a tray-type orthodontic appliance made of a shape memory polymer having a first and second glass transition temperature the method comprising the steps of: forming the tray-type orthodontic appliance to provide the orthodontic appliance with a shape identical to that of perfectly aligned teeth at a temperature above the first glass transition temperature; cooling the orthodontic appliance to fix the shape thereof; forming the orthodontic appliance to have a shape identical to that of the patient's teeth as presently aligned at a temperature above the second glass transition temperature; and cooling the orthodontic appliance to fix the shape thereof.

According to the present invention, the orthodontic appliance may be easily mounted to the patient's teeth with appealing esthetics. In addition, the patient suffers no pain, since the malocclusion of teeth or teeth misalignment is straightened by use of a restoring force of the shape memory polymer.

It is to be understood that both the foregoing general description and the following detailed description of the present invention are exemplary and explanatory and are intended to provide further explanation of the present invention as claimed.

### BRIEF DESCRIPTION OF THE DRAWINGS

The above objects, other features and advantages of the present invention will become more apparent by describing the preferred embodiment thereof with reference to the accompanying drawings, in which:

FIG. 1 is a perspective view illustrating a bracket and a wire of an orthodontic appliance according to a first preferred embodiment of the present invention;

FIG. 2 is a view illustrating the state in which the orthodontic appliance shown in FIG. 1 is applied to teeth;

FIG. 3 is a perspective view illustrating a band-type orthodontic appliance according to a second preferred embodiment of the present invention;

FIG. 4 is a view illustrating the state in which the orthodontic appliance shown in FIG. 3 is applied to teeth;

FIG. 5 is a perspective view illustrating a tray-type orthodontic appliance according to a third preferred embodiment of the present invention;

FIG. 6A is a front view showing a conventional orthodontic method for uprighting a molar;

FIG. 6B is a front view showing the state of molar uprighting using a tray-type orthodontic appliance according to the present invention;

FIG. 7 is a perspective view illustrating a tray-type orthodontic appliance according to a fourth preferred embodiment of the present invention;

FIGS. 8A and 8B are respectively perspective views of a quadrant-tray-type orthodontic appliance and an anterior orthodontic appliance according to the present invention; and

FIGS. 9A and 9B are perspective and cross sectional views of a mouthguard-type orthodontic appliance according to a fifth preferred embodiment of the present invention.

### BEST MODE FOR CARRYING OUT THE INVENTION

Reference will now be made in detail to the preferred embodiments of the present invention; examples of which are illustrated in the accompanying drawings. In the embodiments, similar parts are shown by their corresponding reference numerals throughout the drawings, in which additional explanation thereof will be omitted.

A shape memory polymer used as material for an orthodontic appliance of the present invention will now be described in detail.

Shape memory is the ability of a material to remember its original shape by imparting a particular form to the polymer in a solid state, then cooling the article to a glass transition temperature of the polymer or a lower temperature to set the shape of the new form, and heating the article to a temperature above the glass transition temperature of the polymer to recover its original shape. The materials known to have these properties are shape memory alloys, such as Nitinol, or a shape memory polymer.

International Patent Application No. PCT/US 99/03923 discloses shape memory polymer compositions, and methods of preparation and use thereof. U.S. Pat. No. 5,506,300 issued to Ward et al., entitled “Compositions that soften at predetermined temperatures and the method of making the same,” discloses a shape memory polymer having a predetermined glass transition temperature.

Research on shape memory polymers have attracted a considerable amount of attention, due to its many advantageous characteristics: low density of 1.0 to 1.3 g/cm³; high ratio of shape recovery; easy manipulation; transparency; dyeing ability; and inexpensiveness.

Mechanism of the above shape memory polymer is absolutely different from that of the shape memory alloy. In general, the shape memory property of the polymer is caused when the polymer, such as rubber or plastics, memorizes the absorbed stress and strain by use of viscoelasticity depending upon time in relation to stress and strain. Considering the mechanism of the shape memory polymer, if the shape memory polymer is applied with a certain level of pressure, it can expand five or six times its original size, just like rubber. If the applied pressure is relieved, the polymer returns to its original size. The elasticity as described above is lost at very low temperatures, such as −196° C. Accordingly, if the expanded shape memory polymer is cooled at such a low temperature, that particular shape is fixed. Below the glass transition temperature T_{g}, the polymer does not return to its original shape. Meanwhile, the original shape is recovered by heating the polymer above the glass transition temperature.

The recovery of the original shape is based on thermal, photo or chemical response depending upon the type of polymer, which are respectively named the thermal-responsive shape memory effect, the photo-responsive shape memory effect, and the chemo-responsive shape memory effect.

The differences between a common polymer and the shape memory polymer will now be discussed.

The formation characteristic of a common polymer is in a solid glass state at a temperature lower than the glass transition temperature, while existing in a rubber state having a low modulus of elasticity, thereby making it easy to form at a high temperature. In addition, after the common polymer is deformed at a high temperature, if the applied load is relieved and then the polymer is cooled and once again heated, it will be difficult for the deformed material to recover its original shape, since the formed material exists in the same shape as the cooled shape.

The shape memory polymer has a two-phase structure capable of being reversibly repeated between the softening and the hardening phases. As a result, in accordance with the temperature variation and a setting point (freezing point), which will interfere with the flow of the polymer, it is possible to recover the residual formation when the temperature is raised. It is an object of the present invention to provide an orthodontic appliance manufactured by use of a shape memory effect of a thermal-responsive shape memory polymer, among the several different shape memory polymers mentioned above.

Reference will now be made in detail to the orthodontic appliance manufactured of the shape memory polymer according to the preferred embodiments of the present invention.

### FIRST EMBODIMENT

The orthodontic appliance according to the first preferred embodiment of the present invention will now be described.

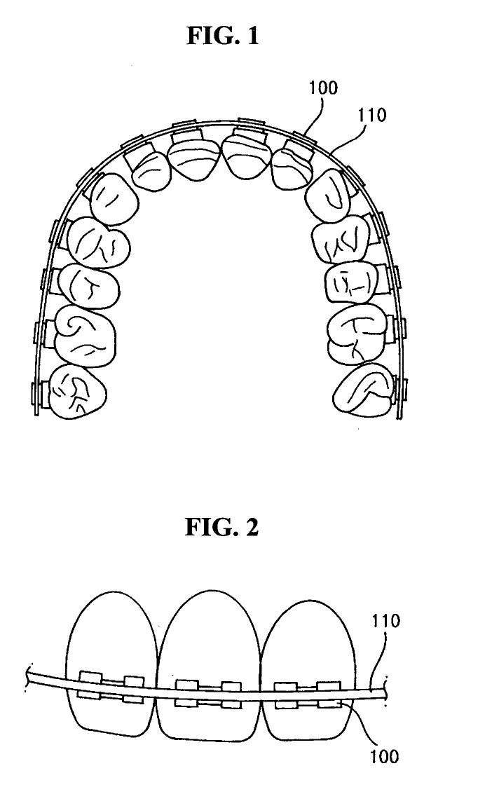

FIG. 1 is a perspective view illustrating the shape of teeth with a bracket attached. FIG. 2 is a view illustrating the state in which the orthodontic appliance shown in FIG. 1 is applied to the teeth.

As shown in FIGS. 1 and 2, the orthodontic appliance of the shape memory polymer according to the present invention is a wire mounted to a slot of the bracket attached to the surface of the teeth, and the wire of the present invention is characterized by being made of a shape memory polymer having a glass transition temperature of 35° C. At that time, the glass transition temperature of the shape memory polymer used for manufacturing the wire for the bracket is set to 35° C., which is the temperature of the oral cavity of a wearer. When the wire for the bracket is installed in the oral cavity, an elastic force is produced at the wire, so that it may recover to its ideal shape memorized previously in order to gradually correct the misaligned teeth of the wearer.

A method of manufacturing the wire by use of the shape memory polymer will now be described.

Powders or pellets of the shape memory polymer are melted, and are then formed to have its original shape. If necessary, the crosslinking of the shape memory polymer may be achieved using a crosslinking agent or a photo-crosslinker. In other words, the shape memory polymer is shaped to the wire according to the present invention.

The wire having its original shape is then applied with stress and strain at a temperature above the glass transition temperature, thereby forming it to a desired shape. When the formed wire is properly bended, a bended length is predetermined in a range for providing the proper elastic force to the teeth.

The shape temporarily formed by the stress and strain is then cooled at a temperature lower than the glass transition temperature.

A wire manufactured using the shape memory polymer has the following benefits: the wire may be formed to be transparent; the wire may be dyed with the same color as teeth; manufacturing cost can be reduced; and the wire can be easily manufactured. In addition, since the shape memory has a constant elastic force, a mild force is continuously applied to the teeth, thereby correcting the misaligned teeth.

The wire manufactured by the above-mentioned method is installed to the slot of the bracket, which is attached to the surface of the teeth in the oral cavity, in a temporarily formed shape. If the wire installed to the slot of the bracket is heated at a temperature higher than the glass transition temperature by the temperature of the oral cavity, a constant elastic force is applied to the teeth when the shape memory effect recovers to its original shape. Proper pressure is continuously applied to the teeth by the elastic force, thereby correcting the misaligned teeth. Contrary to a conventional orthodontic appliance, the present invention may easily carry out orthodontic treatment, without need of periodic adjustment, such as pushing or pulling, on a wire mounted to a bracket. Furthermore, the present invention may carry out orthodontic treatment without causing pain to the wearer.

Since the wire made of the shape memory polymer, according to the embodiment of the present invention, may be utilized together with the bracket made of ceramic, the present invention may manufacture the fixed orthodontic appliance, so that it is not visually distinctive.

### SECOND EMBODIMENT

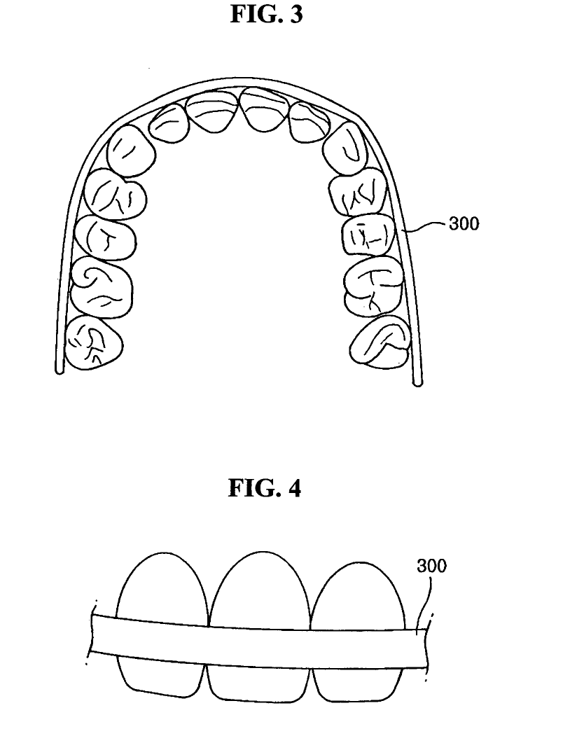

The second preferred embodiment of the present invention relates to a band-type orthodontic appliance. The band-type orthodontic appliance will now be described with reference to FIGS. 3 and 4.

FIG. 3 is a perspective view illustrating the band-type orthodontic appliance according to the present invention.

The band-type orthodontic appliance 300 has a desired width and length, and is made of the shape memory polymer. Preferably, the glass transition temperature of the shape memory polymer forming the orthodontic appliance 300 is 35° C.

The original shape of the band-type orthodontic appliance is identical to that of perfectly aligned teeth obtained after orthodontic treatment, and a temporarily formed shape of the band-type orthodontic appliance is identical to that of the patient's teeth as aligned before orthodontic treatment. If the orthodontic appliance is heated at a temperature higher than the glass transition temperature, the band-type orthodontic appliance according to the embodiment is restored to its original shape, which is identical to teeth that are perfectly aligned after orthodontic treatment.

FIG. 4 is a view illustrating the state in which the orthodontic appliance shown in FIG. 3 is applied to the teeth. As shown in FIG. 4, the band-type orthodontic appliance is attached to the surface of the teeth to be corrected. Preferably, a dental adhesive, i.e., a composite, is used so as to attach the orthodontic appliance to the surface of the teeth.

The method of manufacturing the band-type orthodontic appliance, according to the embodiment, is identical to that of the first embodiment. Thus, the description thereof is omitted herein.

Since the band-type orthodontic appliance of the embodiment is attached to the surface of the teeth by use of the adhesive without attaching the bracket, orthodontic treatment may be easily performed, and expenses may be reduced. In addition, if the band-type orthodontic appliance is dyed with the same color as teeth, the orthodontic appliance will be less noticeable. Furthermore, the teeth are applied with a constant elastic force when the shape memory effect recovers to its original shape. Proper pressure is continuously applied to the teeth by such an elastic force, thereby correcting the misaligned teeth. Therefore, the present invention may easily carry out orthodontic treatment, without need of periodically tightening the orthodontic appliance, which is required in a conventional application. Furthermore, the present invention may carry out orthodontic treatment without causing pain to the wearer.

The band-type orthodontic appliance of the present invention may be applied to the orthodontic treatment of diastema, crowding of teeth, molar uprighting or the like.

### THIRD EMBODIMENT

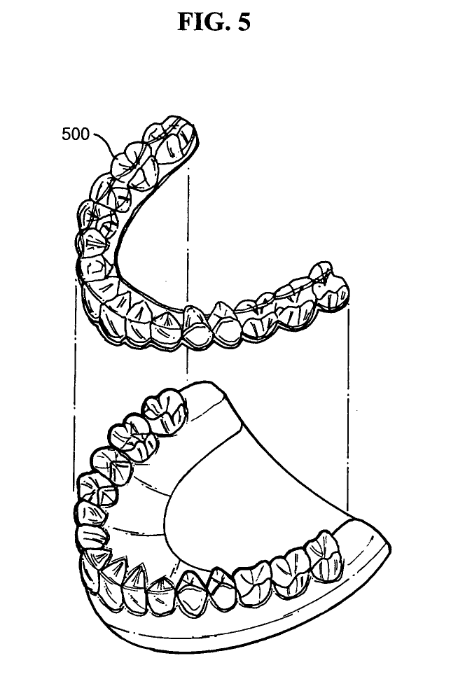

The third preferred embodiment of the present invention relates to a tray-type orthodontic appliance made of a shape memory polymer, which will be referred to as a nasopalatinal tray-type orthodontic appliance in order to distinguish it from the fourth embodiment. The tray-type orthodontic appliance according to the present invention will now be described with reference to FIG. 5.

FIG. 5 is a perspective view illustrating the state in which the nasopalatinal tray-type orthodontic appliance 500, according to the embodiment, is disposed on the upper portion of the teeth.

As shown in FIG. 5, the nasopalatinal tray-type orthodontic appliance, according to the embodiment, is made of the shape memory polymer, and has a shape capable of covering the entire surface of the teeth.

Preferably, the shape memory polymer, according to the present invention, has a glass transition temperature of 35° C. Also, the original shape of the tray-type orthodontic appliance is identical to teeth that are perfectly aligned after orthodontic treatment, and a temporarily formed shape of the tray-type orthodontic appliance is identical to that of the patient's teeth as aligned before orthodontic treatment.

The operation of the nasopalatinal tray-type orthodontic appliance according to the present invention will now be described.

Since the temporarily formed shape of the tray-type orthodontic appliance is identical to that of the patient's teeth as aligned before orthodontic treatment at room temperature or below 35° C., the orthodontic appliance with the temporarily formed shape is placed on the patient's teeth. The orthodontic appliance is installed in the oral cavity. The temperature of the orthodontic appliance is increased to a temperature higher than that of the oral cavity, for example 35° C., and then the orthodontic appliance recovers to its memorized ideal original shape. In the course of transforming the temporarily formed shape to the ideal original shape, the orthodontic appliance gradually applies an elastic force to the teeth, thereby correcting the misaligned teeth.

### FOURTH EMBODIMENT

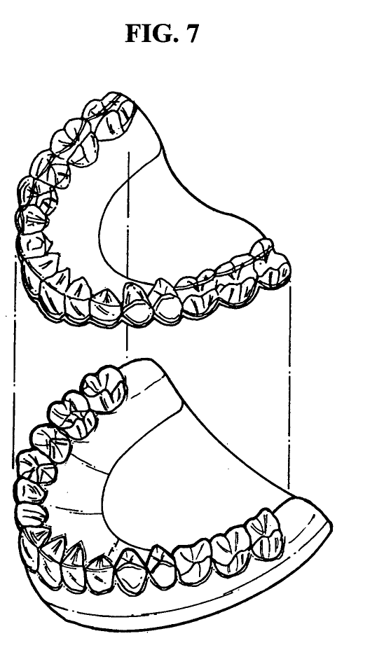

A palatal tray-type orthodontic appliance according to the present invention will now be described with reference to FIG. 7.

The palatal tray-type orthodontic appliance, according to the embodiment, is to cover the entire palate, as well as to cover the teeth, which is contrary to the orthodontic appliance of the third embodiment. The palatal tray-type orthodontic appliance of this embodiment has a shape different from the nasopalatinal tray-type orthodontic appliance described above. However, the material and manufacturing method thereof are identical to those of the nasopalatinal tray-type orthodontic appliance. Therefore, the description thereof will be omitted.

Now, the application field of the nasopalatinal and palatal tray-type orthodontic appliances described above will be described in detail.

1) Crowding of Teeth

The embodiments may be used to solve the crowding of the teeth occurring at a mixed dentition or a permanent dentition. In the case where severe crowding exists, the palatal tray-type orthodontic appliance, which more strongly reacts against the force generated from the movement of teeth during correction, is preferably used. Meanwhile, in the case of the minor teeth crowding, the nasopalatinal tray-type orthodontic appliance is preferably used.

In particular, if the present embodiments are carried out together with proximal disking, a better result will be obtained. The reason is that a lower force will be applied relative to non-disked cases in moving the teeth.

2) Arch Expansion

The present embodiments may be used for the treatment of arch expansion due to the opening of a mid-palatal suture in the mixed dentition. Meanwhile, since greater force is needed upon opening the mid-palatal suture at the permanent dentition, the palatal tray-type orthodontic appliance may be used for the treatment when there is a slight amount of arch expansion.

In the case where the arch expansion is not caused by a skeletal problem, but rather an inherited problem of the teeth, it is preferable to treat narrow arch by use of a nasopalatinal tray-type orthodontic appliance.

3) Retainer

The orthodontic appliance of the present invention may be used as a retainer or a device for minor movement of the teeth after common orthodontic treatment. For example, if the retainer is shaped like the tray-type orthodontic appliance according to the present invention, the oral hygiene of the patient will be improved, and appearance will be improved because of its transparency.

4) Space Maintainer

Mesial inclination of a permanent first molar resulting from an early missing primary molar or extraction of a primary molar will be prevented by using the orthodontic appliance of the embodiment.

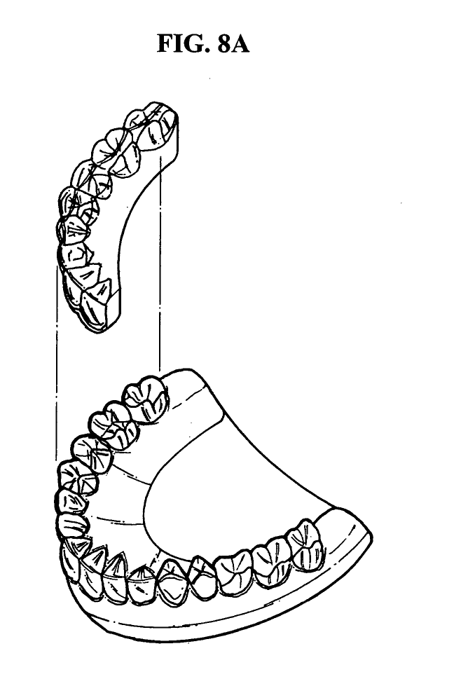

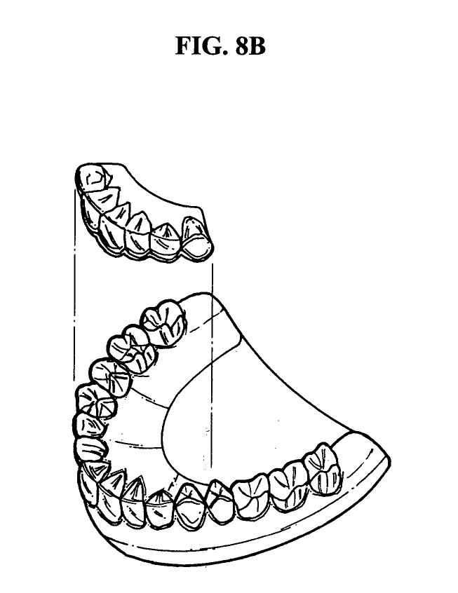

This case does not concern a tray covering the entire arch. A quadrant tray covering a certain portion of the arch may be satisfactory in this case, as shown in FIG. 8A. Preferably, the quadrant tray is adapted to cover half of the maxillary arch or mandibular arch.

5) Molar Uprighting

After the first permanent first molar is extracted, which has not been treated for a long time, the posteriorly positioned tooth adjacent to the missing tooth will topple down forwardly. Thus, the anteriorly positioned tooth is moved rearward. The molar uprighting may be used to solve this problem using the orthodontic appliance according to the embodiments.

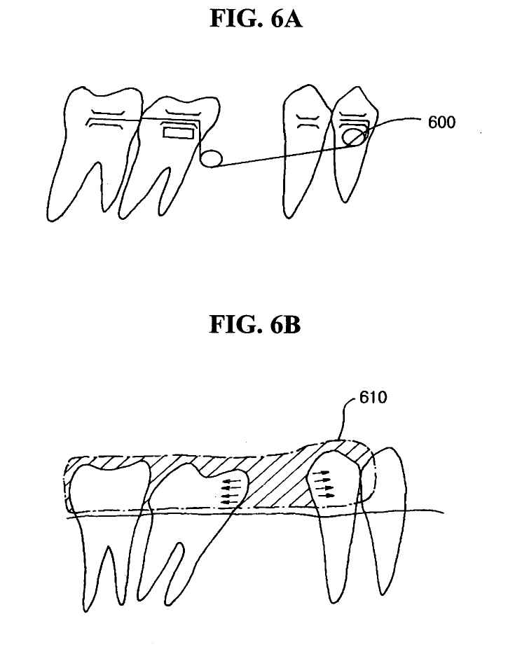

FIG. 6A is a front view showing a conventional orthodontic method for uprighting the molar. FIG. 6B is a front view showing the state of molar uprighting using the tray-type orthodontic appliance according to the present invention.

As shown in FIG. 6A, the conventional orthodontic method utilizes a spring or wire to carry out the molar uprighting. However, the present invention utilizes the tray-type orthodontic appliance manufactured by the shape memory polymer, thereby easily carrying out the molar uprighting.

As shown in FIG. 6A, a partial tray-type orthodontic appliance is preferably utilized to carry out the molar uprighting, instead of a tray-type orthodontic appliance. The partial tray is adapted to enclose only the anteriorly and posteriorly positioned teeth (i.e., the desired teeth) adjacent to the missing tooth.

6) Diastema Closing

Diastema may be closed by use of the orthodontic appliance according to the embodiments. As shown in FIG. 8B, diastema may be treated by using the anterior orthodontic appliance.

The anterior orthodontic appliance is adapted to enclose six teeth from the left canine to the right canine.

### FIFTH EMBODIMENT

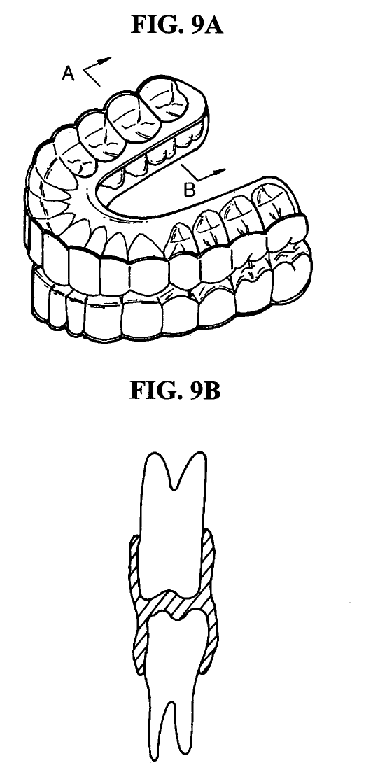

A mouthguard-type orthodontic appliance according to the present invention will now be described with reference to FIGS. 9A and 9B.

FIG. 9A is a perspective view of the mouthguard-type orthodontic appliance according to a fifth preferred embodiment of the present invention. FIG. 9B is a cross-sectional view taken along a line A-B in FIG. 9A, in which the maxillary and mandibular teeth are shown with the orthodontic appliance mounted thereon.

As shown in FIG. 9A, the mouthguard-type orthodontic appliance of the embodiment is made in the shape of a mouthguard in which the tray is integrally formed with the maxillary and mandibular teeth, and is made of the shape memory polymer. The characteristics of the shape memory polymer are substantially identical to those provided by other embodiments, the description of which will be omitted. In addition, the manufacturing method thereof is substantially identical to that mentioned in other embodiments, the description of which will also be omitted.

The mouthguard-type orthodontic appliance using the shape memory polymer, according to the embodiment, may move the relationship of the maxillary and mandibular teeth, in cases of teeth-borne problems, skeletal mandibular protrusion and skeletal maxillary protrusion.

The mouthguard-type orthodontic appliance may be used in cases of maxillary and mandibular cross-bite, maxillary and mandibular arch expansion, or maxillary and mandibular arch construction. In addition, the mouthguard-type orthodontic appliance may intrude the erupted tooth in which the treatment thereof is impossible by a conventional positioner, i.e., an erupted tooth resulting from an early missing tooth or extraction of a tooth on opposite arches.

Meanwhile, the shape memory polymer used for manufacturing the orthodontic appliance, according to the present invention, may be composed of at least two polymers of which the glass transition temperature is different from each other, specifically a fundamental polymer and an additive polymer. Accordingly, the shape memory polymer composed of a polymer composition has two glass transition temperatures.

Preferably, a block copolymer having a hard segment and a soft segment is used as the fundamental polymer. For example, polyurethane, such as polyester urethane, polyether urethane and so forth may be used. Preferably, the glass transition temperature of the fundamental polymer is 25° C., which is lower than the body temperature.

Also, a thermosetting polymer may be used as the additive polymer. For example, DGEBA-type epoxy resin, polystyrene/acrylonitrile copolymer, and so forth may be used. Preferably, the glass transition temperature of the additive polymer is above 35° C.

Physical properties (i.e., the glass transition temperature) of the shape memory polymer may be regulated by adjusting the mixing ratio of the polymers comprising the polymer blend.

The method of manufacturing the orthodontic appliance using the shape memory polymer having two glass transition temperatures, as described above, will now be described.

The two glass transition temperatures are set to first and second glass temperatures, respectively. The first glass transition temperature is set to 35° C., which is the glass transition temperature of the additive polymer, while the second glass transition temperature is set to 25° C., which is the glass transition temperature of the fundamental polymer.

First of all, the tray-type orthodontic appliance is formed to have a shape identical to that of perfectly aligned teeth at a temperature above the first glass transition temperature. The orthodontic appliance is then cooled to fix the shape thereof. The orthodontic appliance is formed to have a shape identical to that of the presently aligned teeth of a patient at a temperature above the second glass transition temperature. The orthodontic appliance is then cooled to fix the shape thereof.

The orthodontic appliance manufactured by the above-mentioned method is maintained in the shape identical to that of the presently aligned teeth of the patient at a temperature below the second glass transition temperature. The orthodontic appliance is maintained in the shape identical to perfectly aligned teeth at a temperature above the first glass transition temperature. Accordingly, while the orthodontic appliance of the present invention is maintained in the shape identical to the presently aligned teeth of the patient at room temperature or low temperature, if it is positioned in the oral cavity of the patient, the orthodontic appliance is formed to have the memorized ideal shape. At that time, an elastic force is produced from the process, thereby correcting the misaligned teeth.

Meanwhile, the orthodontic appliance of the present invention may be removed from the mouth of the patient, if necessary, and then formed to have a shape identical to the present teeth alignment below the glass transition temperature. At that time, in order to form the appliance to its original shape, it may be compressed by use of an air compressor, compressing tools, or by hand. If the orthodontic appliance is again placed in the oral cavity, it will again recover to the form for ideal teeth alignment.

Although the material regarding the block copolymer and thermosetting polymer is suggested herein, these are merely illustrated to help in the understanding and the description of the present invention, and do not restrict the scope of the present invention.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers all modifications and variations of this invention that come within the scope of the appended claims and their equivalents.

Industrial Applicability

The orthodontic appliance made of the shape memory polymer according to the present invention can be easily manufactured to perform orthodontic treatment, and can be manufactured at an inexpensive cost. In addition, the orthodontic appliance of the shape memory polymer also provides appealing esthetics, which can be colored to be identical to a tooth, so that it is not apparently distinguishable from natural teeth.

Since the orthodontic appliance memorizes the shape of perfectly aligned teeth at the temperature of the oral cavity, a constant elastic force is applied to the teeth when the shape memory effect recovers to its original shape. Proper pressure is continuously applied to the teeth by the elastic force, thereby correcting the misaligned teeth. Therefore, the present invention may easily carry out orthodontic treatment, without need of periodic tightening as in a conventional orthodontic appliance. Furthermore, the present invention may carry out orthodontic treatment, without causing pain to the wearer.

1. An orthodontic appliance for straightening misaligned teeth made of a shape memory polymer and formed in a cap-shaped tray capable of covering maxillary or mandibular teeth,
wherein an original shape of the tray orthodontic appliance made of the shape memory polymer is identical to that of perfectly aligned teeth obtained after orthodontic treatment, and a temporarily formed shape of the tray orthodontic appliance is identical to that of a patient's teeth before orthodontic treatment, and
wherein the tray-type orthodontic appliance is restored to the original shape memorized at a temperature above a specified glass transition temperature.

2. The orthodontic appliance of claim 1, wherein the orthodontic appliance is formed in the cap-shaped tray capable of completely covering the entire maxillary or mandibular teeth.

3. The orthodontic appliance of claim 1, wherein the orthodontic appliance is formed in the cap-shaped tray capable of selectively covering predetermined teeth among the maxillary or mandibular teeth.

4. The orthodontic appliance of claim 3, wherein the orthodontic appliance is formed in the cap-shaped tray capable of covering anterior teeth among the maxillary or mandibular teeth.

5. The orthodontic appliance of claim 1, wherein the orthodontic appliance is adapted to cover teeth and a palate when the appliance is used for a maxilla.

6. An orthodontic appliance for straightening misaligned teeth formed in a band having a predetermined width and length,
wherein the band orthodontic appliance made of a shape memory polymer is restored to an original shape memorized at a temperature above a specified glass transition temperature.

7. An orthodontic appliance for straightening misaligned teeth made of a shape memory polymer having a predetermined glass transition temperature and formed in a mouthpiece capable of completely covering maxillary or mandibular teeth,
wherein an original shape of the mouthpiece orthodontic appliance made of the shape memory polymer is identical to that of perfectly aligned teeth obtained after orthodontic treatment, and a temporarily formed shape of the mouthpiece orthodontic appliance is identical to that of a patient's teeth before orthodontic treatment, and
wherein the mouthpiece orthodontic appliance is restored to the original shape memorized at a temperature above a specified glass transition temperature.

8. The orthodontic appliance of any one of claims 1 to 7, wherein the shape memory polymer comprises a polymer composition consisting of a base polymer and a second polymer.

9. The orthodontic appliance of claim 8, wherein the base polymer comprises a block copolymer.

10. The orthodontic appliance of claim 8, wherein the glass transition temperature of the base polymer is below 25° C.

11. The orthodontic appliance of claim 8, wherein the second polymer comprises a thermosetting polymer.

12. The orthodontic appliance of claim 8, wherein the glass transition temperature of the second polymer is above 35° C.

13. The orthodontic appliance of any one of claims 1 to 7, wherein a color of the orthodontic appliance is identical to that of the teeth or is transparent.

14. The orthodontic appliance of any one of claims 1 to 7, wherein the glass transition temperature of the shape memory polymer is 35° C.

15. A method for manufacturing a tray orthodontic appliance made of a shape memory polymer having a first-and second glass transition temperature, the method comprising the steps of:
forming the tray-type orthodontic appliance to provide the orthodontic appliance with a shape identical to that of perfectly aligned teeth at a temperature above the first glass transition temperature;
cooling the orthodontic appliance to fix the shape thereof;
deforming the orthodontic appliance to have a shape identical to that of a patient's presently aligned teeth at a temperature above the second glass transition temperature; and
cooling the orthodontic appliance to fix the shape thereof.

16. An orthodontic appliance for straightening misaligned teeth, the orthodontic appliance comprising a bracket attached to the surface of the teeth and a wire mounted to the bracket, wherein the wire is made of a shape memory polymer having a glass transition temperature so that the wire is restored to the original shape memorized at a temperature above the glass transition temperature.

17. The orthodontic appliance claimed in claim 16, wherein the glass transition temperature is about 35° C.

18. The orthodontic appliance as claimed in claim 16, wherein the shape memory polymer is a thermal-responsive shape memory polymer or a photo-responsive shape memory polymer.
